(19) United States
(12) Patent Application Publication
(10) Pub. No.: US 2011/0159384 A1
(43) Pub. Date: Jun. 30, 2011

(54) CARTRIDGE FOR HYDROGEN PRODUCTION, SYSTEM FOR HYDROGEN PRODUCTION AND CORRESPONDING PROCESS OF MANUFACTURE

(75) Inventors: Roberta GIUFFRIDA, Catania (IT); Salvatore LEONARDI, Aci S. Antonio (IT); Enzo FONTANA, Catania (IT)

(73) Assignee: STMICROELECTRONICS S.R.L., Agrate Brianza (IT)

(21) Appl. No.: 12/974,382

(22) Filed: Dec. 21, 2010

(30) Foreign Application Priority Data
Dec. 30, 2009 (IT) MI2009A002333

(51) Int. Cl. H01M 8/06; C01B 3/04

(52) U.S. Cl. 429/416; 422/129; 423/648.1

(57) ABSTRACT

An embodiment of a cartridge for hydrogen production comprises a reaction chamber having a catalyst and a tank chamber comprising a reactant suitable for reacting with said catalyst for the production of gaseous hydrogen and comprising a fluidic conduit of connection between the tank chamber and the reaction chamber, the cartridge comprising a single body associated with a piston element, said piston element being suitable for defining in said single body said tank chamber and said reaction chamber, said piston element being activated for regulating the flow of the reactant in said fluidic conduit.

### PRIORITY CLAIM

The instant application claims priority to Italian Patent Application No. MI2009A002333, filed Dec. 30, 2009, which application is incorporated herein by reference in its entirety.

### TECHNICAL FIELD

In a general aspect, an embodiment relates to the industrial field for the production of an energy carrier, such as hydrogen, used for being transformed into electric energy, particularly but not exclusively intended for being used in portable electronic applications, or, for being used in a system capable of burning it for making heat or mechanical energy.

In particular, an embodiment relates to a cartridge for the production of hydrogen comprising a reaction chamber having a catalyst and a tank chamber comprising a reactant suitable for reacting with said catalyst for the production of hydrogen, and comprising a connection fluidic conduit interposed between the tank chamber and the reaction chamber.

An embodiment also relates to a process for the production of gaseous hydrogen comprising the steps of:

making a reactant flow from a tank chamber to a reaction chamber; and
producing gaseous hydrogen H₂ making said reactant react with a catalyst present in said reaction chamber.

### BACKGROUND

In the last few years, several solutions have been developed and proposed as being suitable for identifying fuels that allow an easy, clean obtainment of electric, mechanical, and thermal energy.

Thus, systems have been developed that, starting from an appropriate fuel and by means, for example, of reduction oxide reactions, obtain energetic carriers such as, among the preferred ones, hydrogen and methanol, employed in systems of electric energy production. However, the energetic return of the systems supplied with hydrogen is, under the same conditions, greater for some orders of magnitude than the one that can be obtained from systems supplied with methanol.

Great interest has been raised by the use of systems supplied with hydrogen in the realization of electric energy for portable electronic applications in addition to and overcoming the use of traditional batteries, such as for example lithium-ion batteries.

Current rechargeable battery systems, although advantageous in several aspects, have significant limits for the use in state-of-the-art electronic devices, which may require particularly high specific energy (Wh/Kg) and energy density (Wh/l) against an increase of the functionalities of electronic devices and of the “on time” activation time.

An attractive solution is given by a system for the production of electric energy that employs a micro fuel cell (Micro Fuel Cell), which, by means of a proton exchange membrane PEM, transforms the hydrogen received into electric energy and generates water as by-product of the transformation.

FIG. 1 shows a block scheme of such a system 1, which comprises a micro fuel cell 2, and a microreactor 3 for the production of gaseous hydrogen H₂ to be supplied to this micro fuel cell 2.

Starting from a fuel such as for example the sodium tetrahydroborate (NaBH4, also called Sodium Borohydride) or from other hydrogen storage solutions, the microreactor 3 supplies gaseous hydrogen to the micro cell 2 as a by-product NaBO2 (sodium borate) is collected in a storage tank of the reaction by-products. The micro cell 2 separates, by means of a catalyst (usually platinum) the gaseous hydrogen H2 received in protons and electrons and forces, through a polymeric membrane MEA, the passage of the electrons from the anode A to the cathode C of the micro cell 2 through an external circuit (not shown by way of simplicity), thus generating an electric current.

However, for replacing in a satisfactory way the batteries currently used, it may be necessary to provide the application with a considerable “supply” of hydrogen.

To the above aim, having considered the techniques of hydrogen production employed to date, and the reduced sizes of the electronic devices taken into consideration, the above need may be met by using small tanks (cylinders) wherein the hydrogen is stored.

A solution for storing hydrogen includes compressing the hydrogen in the gaseous phase under high pressure, for example approximately 200-350 bar at a temperature of approximately 20° C. This technique may be highly dangerous for the treatments the hydrogen is to be subjected to for storage it in small tanks under the above conditions, and, moreover, these treatments are carried out between the hydrogen production step and the step of its transformation into electric energy, involving respective methodologies, apparatuses, and devices that may be difficult to handle or control.

One may also stock the hydrogen in liquid form at very low temperatures, for example equal to approximately −253° C. for a pressure of one bar. But the liquefaction of hydrogen at these temperatures implies a loss of total energy of 30%. Other drawbacks include that the conversion of the hydrogen into liquid form may require cryogenic containers that, besides being expensive instruments, may require measures for reducing to a minimum the losses of fuel due to evaporation.

At least for these reasons, the use hydrogen as an energetic carrier in portable commercial systems has not yet found significant use despite the potential advantages of using hydrogen.

An alternative solution is shown in U.S. Pat. No. 7,544,431B2 by de Vos et al. granted on Jun. 9, 2009, which is incorporated by reference, and which describes a system for regulating the energy produced by a fuel cell so as to meet the needs of portable electronic devices connected thereto. In particular, as shown in FIGS. 2A and 2B, the system regulates the flow of the reactant at the reaction chamber in response to the difference of pressure between the chamber of collection of the gaseous hydrogen produced and the inlet of the reactant at the reaction chamber, the chamber of collection of the gaseous hydrogen being next to the reaction chamber.

This solution, although advantageous in several aspects, is rather sophisticated and complex and its use may require a tank for the storage of sodium tetraborate, not shown in the figures, as well as a tank for the collection of the by-product of the chemical reaction, NaBO2, at the output of the reaction chamber, likewise not shown. Therefore, this solution often may be viewed as unsuitable for use in portable applications.

One may also use gaseous hydrogen as an energy carrier in systems capable of burning the hydrogen for making heat or mechanical energy, such as for example, internal combustion engines supplied with hydrogen. These systems, however, may suffer from the same drawbacks indicated above, and thus they have not attained an advantageous diffusion yet.

### SUMMARY

An embodiment is a cartridge and a system for hydrogen production and a respective production process that allows controlling the hydrogen production in a simple and efficient way, realizing an extremely compact structure that does not need particular activation instruments and having such structural and functional features as to allow to overcome the drawbacks still affecting conventional cartridges and systems.

An embodiment varies the volume of the reaction chamber in a controlled way.

An embodiment includes a cartridge for hydrogen production comprising a reaction chamber having a catalyst and a tank chamber comprising a reactant suitable for reacting with said catalyst for the production of gaseous hydrogen and comprising a connection fluidic conduit interposed between said tank chamber and said reaction chamber, said cartridge being comprising a single body associated with a piston element, said piston element being suitable for defining in said single body said tank chamber and said reaction chamber, said piston element being activated for regulating the flow of the reactant in said fluidic conduit.

An embodiment of a cartridge comprises control means for activating said piston element, said control means being associated to said fluidic conduit.

Suitably, an embodiment of the fluidic conduit is realized outside said single body and said control means comprise at least one check valve associated with said fluidic conduit.

An embodiment of the piston element comprises a mobile wall interposed between a first end wall and a second end wall of said single body, this mobile wall being connected to moving means.

An embodiment of the moving means are activation elastic means contained in said reaction chamber and suitably preloaded. Said activation elastic means may have an initial compressed position and an uncharged or almost relaxed final position.

In an embodiment, one of the two extreme points of the activation elastic means is tied to said mobile wall and the other to said second end wall.

An embodiment of the cartridge also comprises a removable coupling element that is associated with said reaction chamber, said coupling element having a stocking seat, suitable for receiving a solution with said catalyst, and also having a release mechanism activated for releasing said solution with said catalyst.

Suitably, an embodiment of the reaction chamber comprises an outlet of connection to a further external fluidic conduit for the discharge of the gaseous hydrogen produced.

An embodiment of the cartridge comprises an external seal casing suitable for containing said single body and said fluidic conduit, said fluidic conduit being made in the gap between the side wall of said single body and the side wall of said external casing.

Suitably, an embodiment of the fluidic conduit is in fluid communication through a lower slot with said tank chamber and through an upper slot with said reaction chamber.

An embodiment of the cartridge comprises a bell-like external casing, co-axial and suitable for containing said single body, a lateral gap being made between said external casing and said single body, said single body comprising in correspondence with said reaction chamber a plurality of holes, each hole being provided with a hydrophobic membrane.

An embodiment of the external casing comprises an outlet for the connection of said lateral gap to an external fluidic conduit.

An embodiment of a system for the production of energy of the type comprising a cartridge for hydrogen production associated with a user block where in that the fluidic conduit and the control means are associated with said user block, said user block comprising a fuel cell.

The problem is also solved by an embodiment of a process for the production of gaseous hydrogen comprising the steps of:

making a reactant flow from a tank chamber to a reaction chamber;

producing gaseous hydrogen making said reactant react with a catalyst present in said reaction chamber;

defining said tank chamber and said reaction chamber by arranging in a single body a piston element;

activating said piston element for regulating the flow of said reactant in said fluidic conduit;

regulating the volume of said reaction chamber and of said tank chamber in an inversely proportional way with respect to each other.

Suitably, an embodiment of the process comprises a control step of said piston element.

An embodiment of the process provides for positioning said piston element in said reaction chamber and for activating said piston element by means of preloaded moving means.

Suitably, an embodiment of the process provides realizing said moving means by means of activation elastic means, defining for said activation elastic means a compressed initial position and an almost relaxed final position.

An embodiment of the process also provides realizing a coupling element that may be associated with said single body and for realizing said coupling element substantially box-like and closed comprising a stocking seat for a solution containing said catalyst and to provide a release mechanism controlled for the release of the catalyst solution in said reaction chamber.

### BRIEF DESCRIPTION OF THE DRAWINGS

Characteristics and advantages of a cartridge, of a system for hydrogen production, and of a process will be apparent from the following description of one or more embodiments thereof given by way of indicative and non limiting example with reference to the annexed drawings.

In these drawings:

FIG. 1 shows a schematic view of a conventional system for the production of electric energy;

FIGS. 2A and 2B show a conventional system for hydrogen production;

FIG. 3 shows a schematic perspective view of a cartridge realized according to an embodiment;

FIG. 4 shows a schematic section view of a detail of an embodiment of the coupling element of the cartridge of FIG. 3;

FIGS. 5, 6 and 7 show a schematic, exploded view of the detail shown in FIG. 4 according to an embodiment;

FIG. 8 shows a schematic, perspective, partially exploded view of the cartridge of FIG. 3 according to an embodiment;

FIGS. 9 and 10 show schematic, perspective views of two different details of the cartridge of FIG. 3 according to an embodiment;

FIG. 11 shows a schematic, perspective view of a system for hydrogen production comprising the cartridge of FIG. 3 according to an embodiment;

FIGS. 12 and 13 schematically show, respectively, a perspective and sectional view of further embodiments of the cartridge;

FIG. 14 shows a schematic, perspective view of a further embodiment of the cartridge;

FIGS. 15 and 16 show schematic, perspective, exploded views of an embodiment of the cartridge of FIG. 14;

FIG. 17 shows a schematic, perspective view of a detail contained in an embodiment of the cartridge of FIG. 15;

FIGS. 18 and 19 show the cartridge of FIG. 14, respectively in a perspective view without the external casing and in a section view along a longitudinal plane according to an embodiment;

FIG. 20 shows a schematic, perspective view of an application comprising the cartridge of FIG. 3 according to an embodiment.

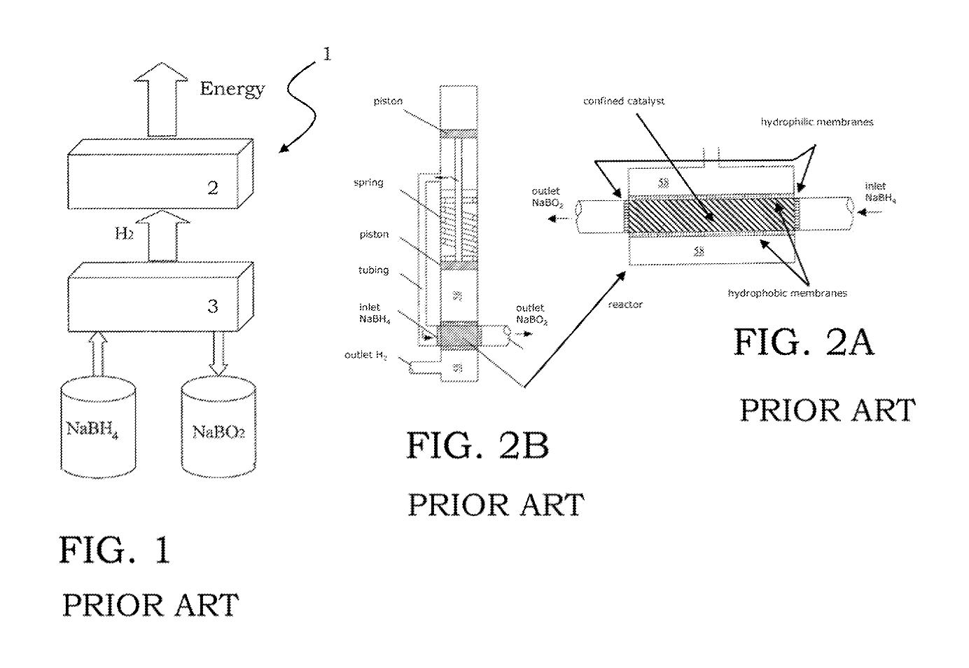

### DETAILED DESCRIPTION

With reference to these figures, 10 globally and schematically indicates an embodiment of a cartridge for the production of gaseous hydrogen H₂.

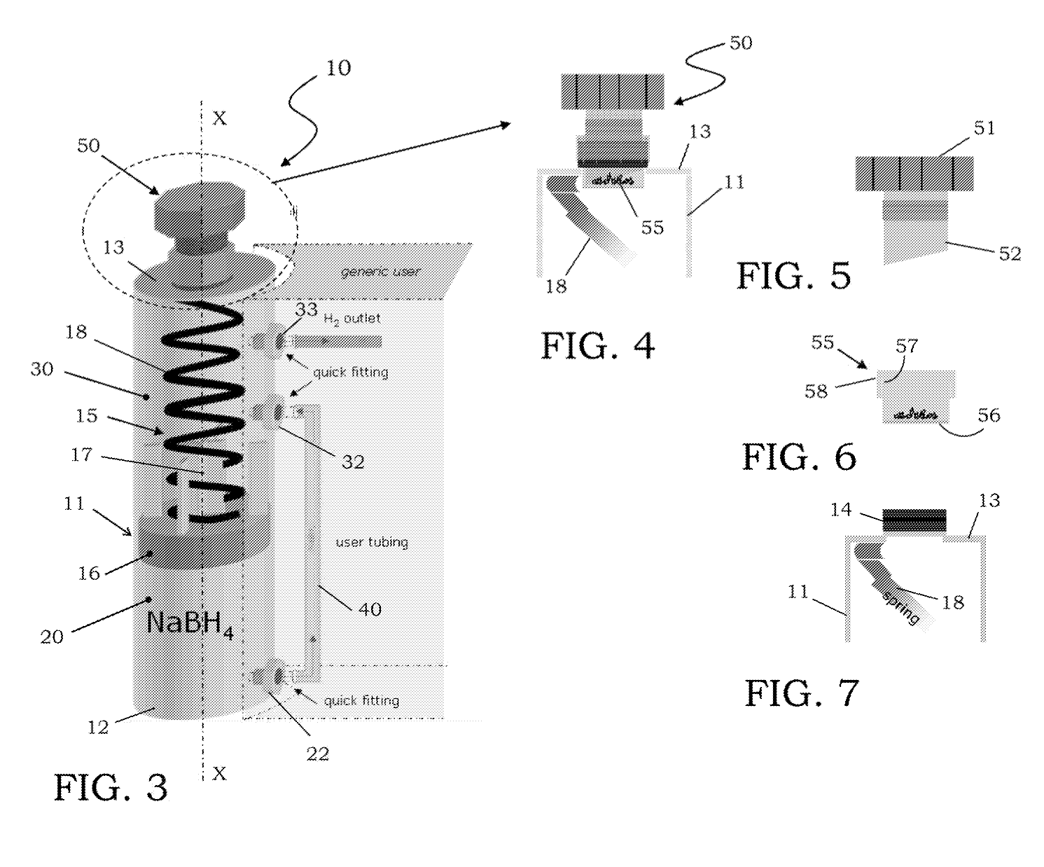

The cartridge 10 for hydrogen production, as shown in FIG. 3, is of the type comprising a reaction chamber 30, having a catalyst, and a tank chamber 20, comprising a reactant suitable for reacting with the catalyst for the production of gaseous hydrogen H₂. The tank chamber 20 is connected to the reaction chamber 30 by means of a fluidic conduit 40.

According to an embodiment, the cartridge 10 is realized in a single piece and in particular it comprises a single body 11, with cylindrical shape and longitudinal axis X-X, enclosed between a first end wall 12 and a second end wall 13. The single body 11 may be realized in a plastic material, such as for example polyethylene PE.

Moreover, according to an embodiment, the single body 11 comprises a piston element 15 arranged inside and having a mobile wall 16 that divides the inner volume of the single body 11 into two distinct and insulated cylindrical volumes suitable for defining the tank chamber 20 and the reaction chamber 30.

Suitably, the piston element 15 also comprises moving means 18 that allow the handling of the mobile wall 16 along the longitudinal axis X-X of the cylindrical single body 11.

The mobile wall 16 then defines in the single body 11 the tank chamber 20, in the portion interposed between the mobile wall 16 and the first end wall 12, and the reaction chamber 30, in the portion interposed between the mobile wall 16 and the second end wall 13.

The mobile wall 16 thus has such sizes as to allow the moving along the inner wall of the single body 11 opposing a slight resistance to the motion and providing in the meantime a tight insulation between the tank chamber 20 and the reaction chamber 30 also when it is moved by the moving means 18. The mobile wall 16 is realized or comprises a separator septum realized with sealing materials with low friction coefficient in a suitable plastic material such as Teflon, various perfluorinated polymers, or EPDM i.e. a thermopolymer made of Ethylene-Propylene-Diene.

The piston element 15 is activated for regulating the flow of the reactant in the fluidic conduit 40.

According to an embodiment, the fluidic conduit 40 of connection between the tank chamber 20 and the reaction chamber 30 is external with respect to the single body 11 and may be associated with mutual coupling.

Suitably, the moving means 18 are activation elastic means associated with the mobile wall 16 for allowing an axial move of the mobile wall 16 from an initial position next to the second end wall 13 to a final position next to the first end wall 12.

The activation elastic means are realized by means of a spring 18 having predetermined mechanical and elastic characteristics. The spring 18 is contained in the reaction chamber 30 with the ends associated respectively with the second end wall 13 and with the mobile wall 16.

According to an embodiment, the spring 18 is of the type with circular helix, with circular section turns. In a different embodiment, the spring is with conical helix and/or with rectangular section turns.

Naturally, the physical and geometric characteristics of the spring 18, such as the elasticity module, the number of turns, the diameter of the wire and the external diameter of the turns are in proportion to the sizes of the single body 11 and in particular of the tank chamber 20 and of the reaction chamber 30 and they are such as to regulate the flow of the reactant in the fluidic conduit 40, in proportion to the production of gaseous hydrogen H₂ to be produced in the reaction chamber 30. The spring 18 is associated with the mobile wall 16 by means of a stop element 17 projecting inside the reaction chamber 30 in the direction of the longitudinal axis X-X.

The stop element 17, according to an embodiment shown in FIG. 9, comprises two bulkheads arranged crosswise with respect to each other and associated perpendicularly to the mobile wall 16 projecting in the direction of the second end wall 13. The stop element 17 has such sizes and technical characteristics as to allow tying the end of the spring 18, possibly with the help of a joint, a glue, or a weld.

The other end of the spring 18 is fixed to the second end wall 13 by means of a glue or a further stop element or is simply leant against the second wall 13, according to the specific design needs.

According to an embodiment, the spring 18 is suitably preloaded and passes from an initial compressed position, next to the second wall 13, to an uncharged or almost relaxed extended final position elongated towards the first wall 12. In the case of almost relaxation, the spring 18 still has a residual compression force.

When the spring 18 is in the compressed initial position, the mobile wall 16 defines a minimum volume for the reaction chamber 30 and a maximum volume for the tank chamber 20, vice versa instead, when the spring 18 is in the extended final position.

During the extension of the spring 18, the mobile wall 16 is thrusted and compressed, in a way corresponding to the elastic force or energy released by the spring 18, the volume of the tank chamber 20, allowing the reactant solution, i.e. the solution of sodium tetrahydroborate NaBH₄, to pass to the reaction chamber 30 through the fluidic conduit 40.

In other words, the mobile wall 16 activated by the spring 18 generates a motion of the sodium tetrahydroborate NaBH₄ from the tank chamber 20 to the reaction chamber 30 proportional to the elastic force released by the spring 18.

Thus, a suitable regulation of the physical and geometric characteristics of the spring 18, during the design step, defines the operation capacity of the spring 18 of the piston element 15 and thus defines the capacity of the fluidic conduit 40 i.e. the amount of reactant that from the tank chamber 20 passes to the reaction chamber 30.

Further, according to an embodiment, the cartridge 10 comprises control means suitable for activating the piston element 15, and in particular the spring 18, allowing the passage of the reactant in the fluidic conduit 40.

According to an embodiment, the control means comprise at least one check valve 22, 32 associated with the fluidic conduit 40, which allows making the reactant flow in a selective way by means of the valve opening.

The tank chamber 20 contains a reactant and in particular a chemical hydride, such as sodium tetrahydroborate NaBH₄, under the form of aqueous solution, which is used as storage source for the hydrogen. The sodium tetrahydroborate introduced in the reaction chamber 30 may react with a solution containing the catalyst for the production of hydrogen, according to the known reaction:

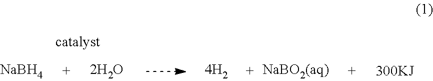

This reaction (1) is exothermic, i.e. it does not require heat to occur, and it takes place under environmental pressure and temperature. Moreover, the reaction by-product or waste, the sodium borate NaBO₂, is soluble in water and is not polluting.

To make this aqueous solution of sodium tetrahydroborate NaBH₄ not flammable and stable in air towards the production of gaseous hydrogen H₂, for the tank chamber 20 an alkaline environment is used.

Moreover, the catalyst may be a metal of the group VIIIB of the periodical table of the elements, in particular a metal chosen among Cobalt, Nickel, Platinum and Ruthenium, for example, Ruthenium on a carbon substrate.

The efficiency of the conversion reaction (1) and in particular the dosage of the catalyst and of the sodium tetrahydroborate NaBH₄ may be optimized so as to make the development of gaseous hydrogen H₂ immediate at the moment of the contact of the solution of sodium tetrahydroborate NaBH₄ with the solution of catalyst, so that all the hydrogen atoms present in the molecules of sodium tetrahydroborate NaBH₄ and in the molecules of water are converted into gaseous hydrogen H₂. Moreover, this reaction (1) may be optimized so that the production of gaseous hydrogen H₂ is cut off in the moment when the flow of reactant through the fluidic conduit 40 is cut off.

According to an embodiment, the stoppage of the flow of reactant is obtained temporarily with the closure of the check valve 22, 32 or definitely when all the sodium tetrahydroborate NaBH₄ is transferred from the tank chamber 20 to the reaction chamber 30.

According to an embodiment, the mutual coupling between the fluidic conduit 40 and the single body 11 occurs by means of a check valve 22, which is a first quick coupling element, suitably associated with an outlet of the tank chamber 20, and by means of a second check valve 32, which is a second quick coupling element, associated to an inlet of the reaction chamber 30.

The positioning of the outlet of the tank chamber 20 and of the inlet in the reaction chamber 30 occurs according to design specifications, for example, the outlet is positioned next to the first end wall 12, while the inlet is for example, positioned next to the mobile wall 16 in its initial position.

According to an embodiment, the first and the second check valve 22, 32 are realized with the so called “quick fittings” that are self-locking valves of the male-female type allowing the passage of the fluid only when the two male and female connections are coupled, while they block the passage of fluid when the two parts are disconnected.

In particular, the ends of the fluidic conduit 40 are associated with respective portions of female valve 21, 22, shown in FIG. 10, of “quick-fitting” couplings while the corresponding portions of male valve are associated with the outlet of the tank chamber 20 and with the inlet of the reaction chamber 30.

The reaction chamber 30 also has a further outlet with a third quick coupling element 33, positioned next to the second end wall 13 which allows the transmission of the gaseous hydrogen H₂ produced to a portable electronic application that may be suitably associated. In correspondence with this outlet a hydrophobic filter is positioned so as to block possible discharges of the solution from said outlet. The position of the outlet of the reaction chamber 30 indicated next to the second end wall 13 may be particularly advantageous when the cartridge 10 has a working position similar to what is shown in FIG. 3, i.e. the single body 11 arranged vertically along the axis X-X with the tank chamber 20 being lower and the reaction chamber 30 being upper.

According to an embodiment, the reaction (1) does not require particular environmental conditions in terms of pressures or temperature and the reaction by-products of the solution of sodium tetrahydroborate NaBH₄ with the catalyst, i.e. the borates, are maintained in the reaction chamber 30 and precipitate towards the mobile wall 16.

According to a further embodiment, the cartridge 10 also has a coupling element 50 that may be removable associated with the reaction chamber 30. The coupling element 50 is suitably cap-like shaped and comprises a head 51 a hollow cylindrical shank 52 projecting axially from said head 51 and being partially threaded. The coupling element 50 may be realized in plastic material.

The coupling element 50, as shown in FIGS. 5-7, comprises, moreover, a release mechanism. The release mechanism comprises a stocking seat 55 suitable for receiving the catalyst and the water necessary for the reaction of the sodium tetrahydroborate NaBH₄ in the reaction chamber 30.

The stocking seat 55 is substantially a hollow cylindric body, which is closed on the bottom by a base 56 and has an edge 57, opposed to the base 56, that is threaded in the inner part of the hollow cylindrical body 55. The seat 55 is suitably countershaped to the shank 52, which is connected through screwing in correspondence with the edge 57.

The base 56 may be realized in such a material as to be perforated by the shank 52. The shank 52 is longer than the seat 55 and such as to allow, with a greater screwing than the shank 52 to the seat 55, the breakage of the seat 55 and the discharge of the catalyst and of the water contained in the seat 55 itself.

The seat 55 finally comprises in correspondence with the edge 57 a coupling wing 58 which is substantially “L”-like shaped, curved outside the hollow cylindrical body 55, and facing the base 56. The coupling wing 58 has such a distance from the side wall of the hollow cylindrical body 55 as to allow the insertion of a portion of shank 14, this latter being hollow, threaded and projecting axially from the single body 11. As shown in FIG. 7, the portion of shank 14 projects axially along the longitudinal axis X-X from the second end wall 13 so as to allow the connection through screwing or triggered with the coupling wing 58 of the coupling element 50.

In particular, as shown in FIG. 4, the seat 55 of the release mechanism is filled in with the catalyst and the water and sealed through screwing of the shank 52 of the coupling element 50 on the edge 57 of the stocking seat 55. Subsequently, the coupling wing 58 is associated with the portion of shank 14 with the insertion of the seat 55 in the portion of shank 14 itself and then in the reaction chamber 30 and, through a further screwing of the shank 52 to the stocking seat 55, the base 56 is perforated and opened and the catalyst and the water fall into the reaction chamber 30.

The coupling element 50 is a safety measure for the cartridge 10, in fact, since the catalyst and the water are inserted in the stocking seat 55 of the release mechanism, any possible non controllable contact is avoided between the catalyst and the solution of sodium tetrahydroborate NaBH₄ thus avoiding a possible generation of non desired gaseous hydrogen H₂.

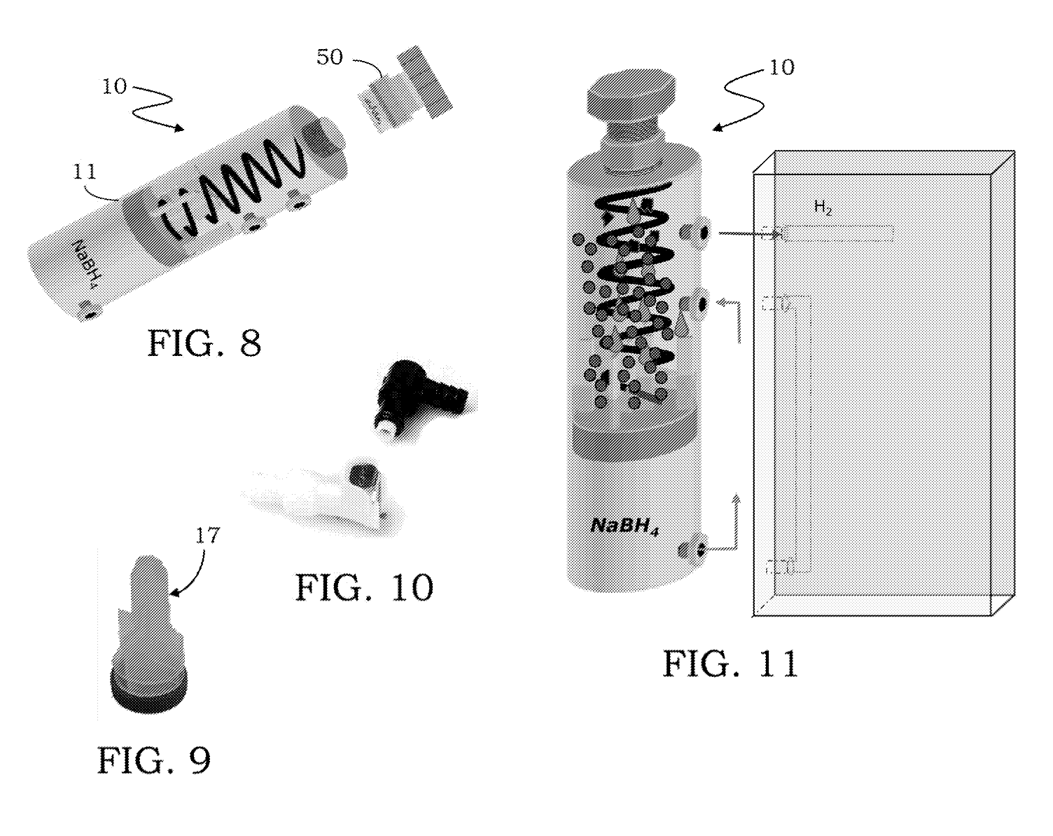

As regards the operation, as shown in FIG. 11, the cartridge 10, in its position of maximum charge, has the spring 18 compressed in the initial position, the reaction chamber 30 in its minimum volume and the tank chamber 20 in its maximum volume. In one embodiment, as shown in FIG. 8, the coupling element 50 is detached from the single body 11 and the portion of shank 14 is closed with an external protection such as for example a cap or with a wall removable by a user or that can be perforated.

The coupling element 50 is associated with the cartridge 10 by screwing or trigger-wise connecting the coupling wing 58 to the portion of shank 14 projecting from the single body 11. Then, by activating the head 51, the shank 52 that perforates the base 56 of the seat 55, and, possibly, the external protection, are further screwed to the portion of shank 14, allowing the catalyst and the water contained in the seat to be released in the reaction chamber 30.

Subsequently, the fluidic conduit 40 is connected to the cartridge 10 and in particular to the single body 11 by fixing the quick-fitting couplings to the outlet of the tank chamber 20 and to the inlet of the reaction chamber 30. Subsequently, with the activation of the control means, and in particular with the opening of the check valves 22, 32 the piston element 15 is activated and the mobile wall 16 compresses the volume of the tank chamber 20. This allows the solution of sodium tetrahydroborate NaBH₄ to flow in the reaction chamber 30 and to react with the catalyst and the water present for the production of gaseous hydrogen H₂.

In particular, the activation of the piston element 15 generates mechanical work, regulated by the elastic deformation of the preloaded spring 18, and allows controlling the motion of the sodium tetrahydroborate NaBH₄. Even more in particular, the capacity of the solution of sodium tetrahydroborate NaBH₄ may be suitably parameterized by making the characteristics of the spring 18 vary in relation to the geometric characteristic of the cartridge 10 i.e. of the reaction chamber 30, of the tank chamber 20 and of the fluidic conduit 40.

The cartridge may be realized so as to have a capacity of the reactant in the fluidic conduit 40 from a few microlitres/minute to some hundreds of microlitres/minute allowing the use in different fields of application.

Moreover, by controlling the amount and the typology of the catalyst used in the reaction chamber 30, it may be possible to control the amount of gaseous hydrogen H₂ developed.

Through the outlet of the reaction chamber 30, the gaseous hydrogen H₂ produced is then conveyed to a suitable application.

In particular, the spring 18 is preloaded so that the work supplied by the spring 18 corresponds to the energy necessary for making all the solution of sodium tetrahydroborate NaBH₄ pass from the tank chamber 20 to the reaction chamber 30.

At the end of the reaction process, for replacing the cartridge 10, the fluidic conduit 40 is released from the single body 11 by means of the quick coupling elements 22, 32 i.e. the “quick-fittings” and a new cartridge 10 is connected.

By means of a voluntary cut-off of the flow of the reactant in the reaction chamber 30, for example by operating on one of the check valves 22, 32, the flow of the solution of sodium tetrahydroborate NaBH₄ in the reaction chamber 30 is blocked and thus almost at once the production of gaseous hydrogen H₂ is blocked. The successive opening of the check valve 22, 32 allows the immediate resumption of the production of hydrogen H₂.

An embodiment has several variations, all within the same several concept.

In the following description reference will be made to the cartridge as previously described and details and cooperating parts having the same structure and function will be indicated with the same acronyms and reference numbers.

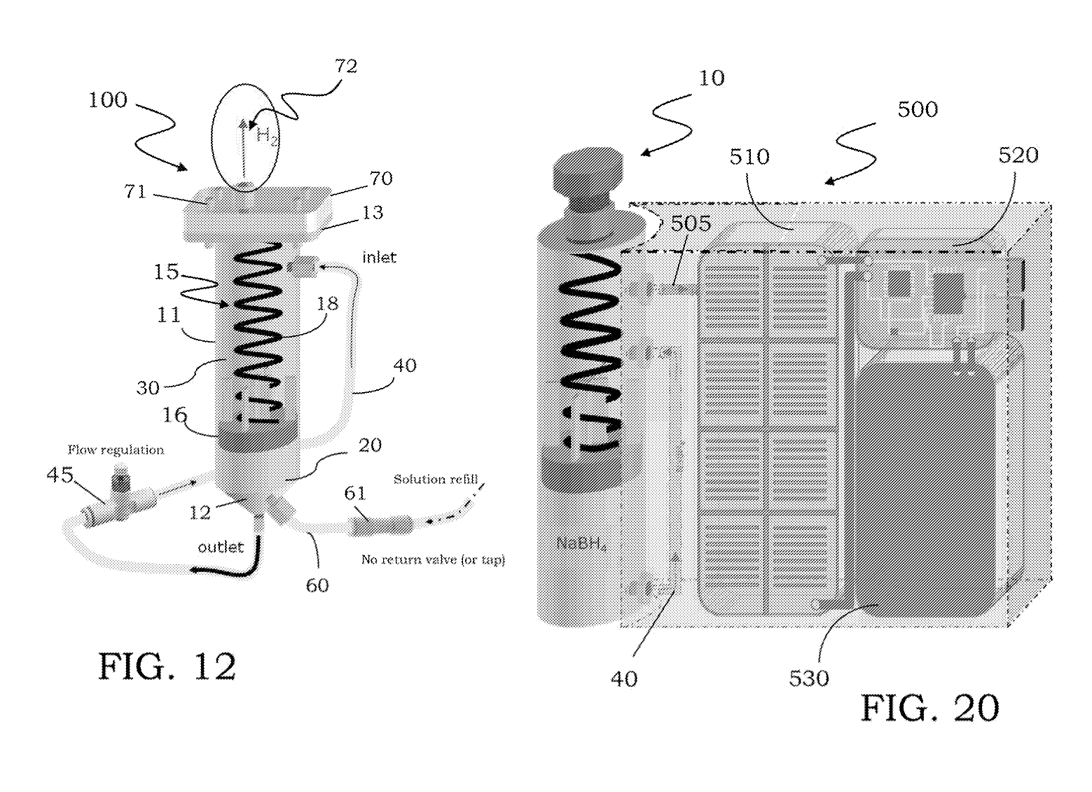

A first embodiment of the cartridge is shown in FIG. 12 and indicated with 100. The cartridge 100 comprises a single body 11 divided into two tight volumes separated by a piston element 15. The single body 11 is a hollow cylindrical body interposed between a first cone-like shaped end wall 12 and a second flat end wall 13.

In particular, the piston element defines a lower tank chamber 20 in correspondence with the first end wall 12, and an upper reaction chamber 30. Suitably, the piston element 15 is positioned in the reaction chamber 30.

According to an embodiment, the piston element 15 comprises a mobile wall 16 activated by moving means 18. The moving means 18 are realized by means of a spring interposed between the second end wall 13 and the mobile wall 16 itself. The spring 18 is suitably preloaded with an initial compressed position and close to the second end wall 13 and a final elongated position next to the first end wall 12. In the final position, the spring 18 being uncompressed or almost uncompressed.

The tank chamber 20 is connected to the reaction chamber 30 by means of an external fluidic conduit 40. Suitable control means are associated with the fluidic conduit 40 and allow the controlled passage of the reactant as well as the activation of the piston element 15. In an embodiment, the control means are defined by a check valve 45 interposed between the ends of the fluidic conduit 40.

The tank chamber 20 has the outlet positioned below the first end wall 12, for allowing an easier discharge of the solution of sodium tetrahydroborate NaBH₄ at the fluidic conduit 40. Moreover, the tank chamber 20 has a further conduit 60 interposed between an external tank, not shown, and an inlet that allows an easy recharging of the solution of sodium tetrahydroborate NaBH₄. The further conduit 60 may have a further check valve or a tap 61.

The ends of the further conduit 60 as well as the inlet of the tank chamber 20 may be provided with quick set coupling elements, of the “quick-fitting” type.

In an embodiment, the reaction chamber 30 comprises a seal element 70, realized as a wall arranged on top and coupled with removable blocking means 71 to the second end wall 13. The removable blocking means 71 are suitable screws arranged peripherally with respect to the seal element 70 for the connection to the second end wall 13.

The seal element 70, suitably released and raised from the second end wall 13 allows inserting the catalyst and the water into the reaction chamber 30. The seal element 70 and the second end wall 13 comprise an outlet 72 for the transmission of the gaseous hydrogen H₂ produced by the cartridge 100 when the solution of sodium tetrahydroborate NaBH₄ is made to flow through the fluidic conduit 40 to the reaction chamber 30 reacting with the catalyst and the water present.

According to an embodiment, with the activation of the control means and in particular with the opening of the check valve 45, the spring 18 activated moves the mobile wall 16 that compresses the tank chamber 20 making the solution of sodium tetrahydroborate NaBH₄ flow through the fluidic conduit 40 into the reaction chamber 30.

The spring 18 may be compressed so as to suitably regulate the capacity of the solution in the fluidic conduit 40.

The deactivation of the control means, i.e. the closure of the flow regulation valve 45, allows the cut off of the production of gaseous hydrogen H₂. In particular, by blocking the motion of the spring 18 i.e. its elongation, the mobile wall 16 of the piston element 15 as well as the flow of the sodium tetrahydroborate NaBH₄ in the fluidic conduit 40 are blocked.

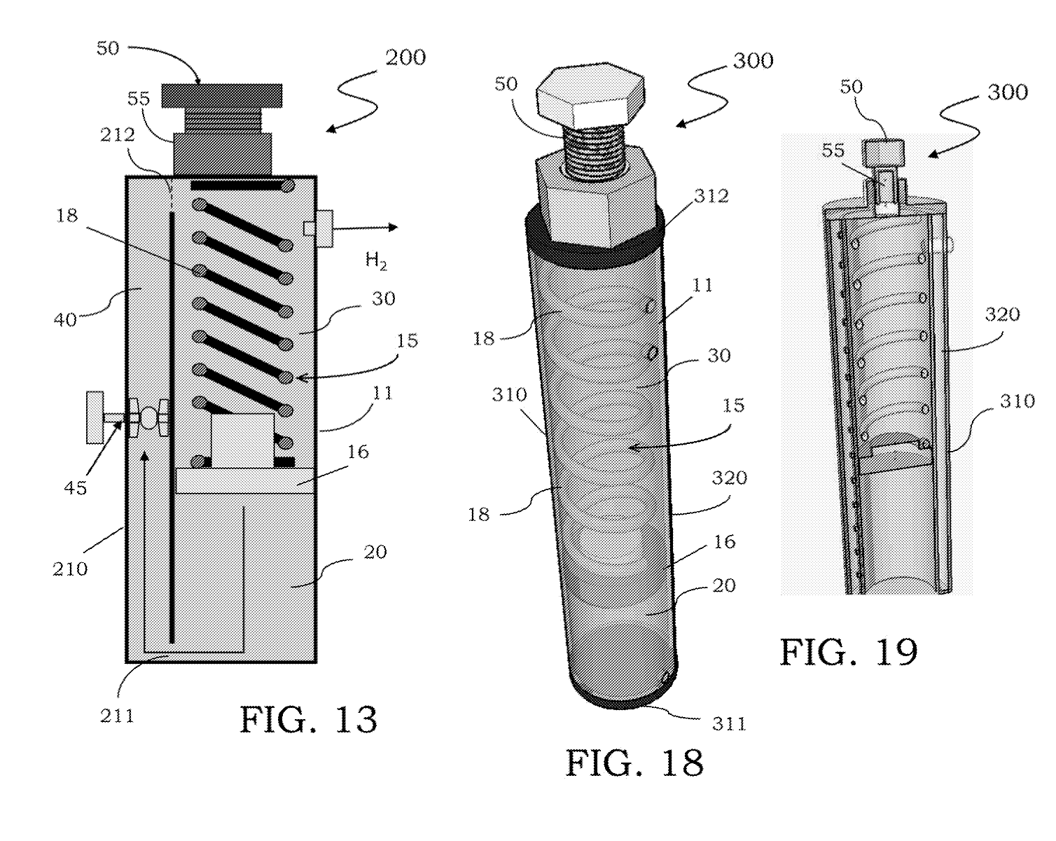

A further embodiment of the cartridge is shown in FIG. 13 and indicated with number 200. The cartridge 200 comprises a single body 11 divided by a piston element 15 into a lower tank chamber 20 and an upper reaction chamber 30, wherein the moving means 18 of the piston element 15 are positioned.

According to an embodiment, the cartridge 200 has a seal external casing or external bell 210 that comprises the single body 11 and the fluidic conduit 40.

In particular, the external casing 210 is a substantially cylindric, hollow body and a fluidic conduit 40 is suitably made in the longitudinal gap between the side wall of the single body 11 and the side wall of the external casing 210. The tank chamber 20 is connected to the reaction chamber 30 by means of the external fluidic conduit 40 which comprises control means, defined by a check valve 45, which allow to activate the passage of the reactant to the reaction chamber 30. Moreover, the fluidic conduit 40 is in fluid communication through a lower slot 211 with the tank chamber 20 and through an upper slot 212 with the reaction chamber 30.

Suitably, the check valve 45 is activated by an operation stem positioned outside the external casing 210.

According to an embodiment, the capacity of the flow of the solution of sodium tetrahydroborate NaBH₄ in the fluidic conduit 40 is controlled by the thrust of the piston element 15 activated by the suitably preloaded spring 18.

Moreover, according to an embodiment, the cartridge 200 comprises a coupling element 50, as previously described, that may be suitably associated with the reaction chamber 30, which comprises a stocking seat 55 for the catalyst and the reaction water that are selectively released in the reaction chamber 30.

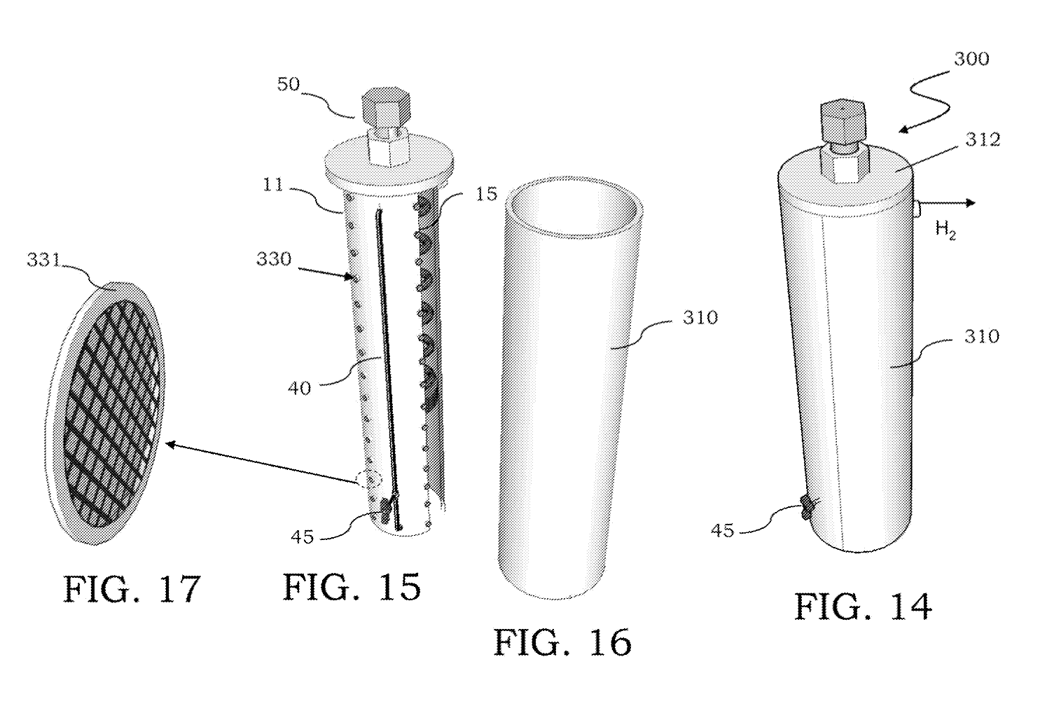

A further embodiment of the cartridge is shown in FIGS. 14-19 and indicated with 300. The cartridge 300 comprises a single body 11 divided into two tight volumes separated by a piston element 15 which defines in said single body 11 a tank chamber 20 and a reaction chamber 30. The tank chamber 20 is connected to the reaction chamber 30 by means of an external fluidic conduit 40 comprising control means, defined by a check valve 45, as shown in FIG. 15.

According to an embodiment, the piston element 15 is in the reaction chamber 30 and comprises a mobile wall 16 activated by moving means 18. As shown in FIGS. 18 and 19, the moving means comprise a spring 18 interposed between the second end wall 13 and the mobile wall 16. The suitably preloaded spring 18 has an initial compressed position next to the second wall 13 and a final elongated position next to the first end wall 12.

As shown in FIG. 16, the cartridge 300 comprises a seal external casing or external bell 310, realized by means of a hollow cylindrical body arranged axially with respect to the single body 11.

The external casing 310 has a greater diameter than the single body 11 so as to contain the single body 11 with the formation of a ring-like gap 320, as shown in FIG. 19.

The external casing 310 is located between two end walls 311 and 312 that may, in some embodiments, respectively define also the first end wall 12 and the second end wall 13 of the single body 11.

The fluidic conduit 40 is positioned in the ring-like gap 320 and the check valve 45 is activated by an operation stem positioned outside the external casing 310, as shown in FIGS. 14 and 15.

According to an embodiment, the single body 11 comprises a plurality of holes 330 realized in correspondence with the side wall of the reaction chamber 30, for example, along axial directions and equidistant from each other. Each hole 330 is provided with a hydrophobic membrane 331 that allows only the gas and not the liquid to pass, as shown in FIG. 17. In this case, the membrane 331 lets the gaseous hydrogen H₂ produced pass but blocks the solution of catalyst or the solution of sodium tetrahydroborate NaBH₄ that flows in the reaction chamber 30. A suitable microporous membrane 331 may be the one known with the trademark CELGARD®.

Moreover, according to an embodiment, the cartridge 300 comprises a coupling element 50 that may be suitably associated with the reaction chamber 30 and in particular with the second end wall 312, as shown in FIG. 19. The coupling element 50 comprises a stocking seat 55 for the catalyst and the reaction water that are released inside the reaction chamber 30 after that the coupling element 50 is associated with the cartridge 300.

According to an embodiment, the capacity of the flow of the solution of sodium tetrahydroborate NaBH₄ in the fluidic conduit 40 is controlled by the thrust of the piston element 15 activated by the suitably preloaded spring 18. The mobile wall 16 activated by the spring 18 reduces the volume of the tank chamber 20 and increases in a corresponding way the volume of the reaction chamber 30, in the meantime the solution of sodium tetrahydroborate NaBH₄ is induced, through the fluidic conduit 40, from the tank chamber 20 to the reaction chamber 30 where it reacts with the catalyst for the production of gaseous hydrogen H₂. The gaseous hydrogen H₂ produced passed through the holes 330 and the membranes 331 from the reaction chamber 30 to the ring-like gap 320 and through an outlet, positioned in the side wall of the external casing 310, it is conveyed to an external application.

A cartridge according to an embodiment operates in an independent way with respect to its space position.

Further embodiments of the cartridge may have the piston element 15 positioned in the tank chamber 20. Naturally, this embodiment may be applied to all the embodiments described or to a combination thereof. According to an embodiment, the piston element comprises the moving means interposed between the mobile wall 16 and the first end wall 12 suitably charged i.e. elongated in such a way that when activated they move the mobile wall 16 towards the first end wall 12 compressing in the meantime the volume of the tank chamber 20 and making the sodium tetrahydroborate NaBH₄ flow to the reaction chamber 30.

Naturally, one may note how all the embodiments indicated of the cartridge and their possible combinations may be realized in a disposable or rechargeable way.

In this latter case, it may be necessary to eliminate the reaction by-products from the reaction chamber 30, to recover the piston element 15 with the spring 18 in the initial position and to fill in the tank chamber 20 with reactant.

A cartridge according to an embodiment may be employed in a portable current supplier 500, such as for example PPS acronym of Portable Power Supplier, shown in FIG. 20, which is a supplier that supplies energy according to a standard USB (universal Serial Bus).

In particular, the supplier 500 comprises a fuel cell block 510 connected to a cartridge 10 by means of a conduit 505 interposed between the outlet of the reaction chamber 30 and an inlet to the fuel cell block 510.

Moreover, the supplier 500 comprises a fluidic conduit 40 associated with control means for the activation of the piston element 15 of the cartridge 100. The fluidic conduit 40 is connected to the cartridge 10 to make the sodium tetrahydroborate NaBH₄ flow from the tank chamber 20 to the reaction chamber 30 while at least one check valve 45 or a quick coupling element 22, 32 are suitably open and allow the activation of the spring 18 of the piston element 15.

The fuel cell block 510 is also connected to a control and conditioning circuit 520 which is in turn connected to a buffer battery 530 and also to a portable external application, not shown in the figure, connected for example by means of ports of the USB type.

The cartridge 10 defines for the supplier 500 a package of energy used for recharging the buffer battery 530 which is subsequently used for recharging in turn one or more portable electronic devices through the gates USB.

According to an embodiment, the supplier 500 is a fixed system that allows generating electric energy in an ecologic, clean way, without the connection to a main electric network.

An embodiment also relates to a process for the production of gaseous hydrogen H₂ by means of a cartridge as previously described for which details and cooperating parts having the same structure and function will be indicated with the same numbers and reference acronyms.

An embodiment comprises the step of making a reactant flow from a tank chamber 20 to a reaction chamber 30 and the step of making the reactant react in the reaction chamber 30 with a catalyst for the production of gaseous hydrogen H₂.

According to an embodiment, the process comprises the steps of:

defining in a single body 11 by means of a piston element 15 the tank chamber 20 and the reaction chamber 30;

activating said piston element 15 for regulating the flow of the reactant in the fluidic conduit 40;

increasing the volume of the reaction chamber 30 in a way directly proportional to the volume decrease of said tank chamber 20.

Suitably, the process comprises a control step of said piston element 15 for allowing the passage of the reactant in the fluidic conduit 40.

According to an embodiment, the piston element is positioned in said reaction chamber 30 and comprises a mobile wall 16 interposed between the tank chamber 20 and the reaction chamber 30 suitably activated by means of preloaded moving means 18.

An embodiment of a process allows realizing the moving means 18 by means of activation elastic means, i.e. a spring, suitably positioned in the reaction chamber 30. Moreover, the spring 18 has an initial compressed position and a uncompressed or almost uncompressed final position, so that the energy stored corresponds to the energy necessary for making all the reactant pass from the tank chamber 20 to the reaction chamber 30.

In particular, an embodiment of a process provides activating the preloaded spring 18 that activates the mobile wall 16 by compressing the volume of the tank chamber 20. Then, the process provides making the reactant pass in the reaction chamber 30 through the fluidic conduit 40 when suitably open.

According to a further embodiment, a process provides the step of realizing a coupling element 50 substantially box-like and closed comprising a stocking seat 55 for the catalyst and the water and provides a release mechanism 56, 57 suitably controlled for the release of the catalyst and of the water contained directly in the reaction chamber 30.

Moreover, a process provides the step of associating the coupling element 50 with the reaction chamber 30 and of activating the release mechanism for the release of the catalyst and of the water prior to the activation of the spring 18.

An advantage of an embodiment of a cartridge stays in its uncommon compactness as well as in its use simplicity. In fact, the piston element realized in a single body allows extremely reduced spaces with respect to prior solutions, and, moreover, the control means allow a selective activation of the cartridge in relation to the need for power.

A further advantage of an embodiment of a cartridge is the versatility of use since cartridges with extremely reduced sizes or considerable sizes may be realized. The possibility is in fact to be noted to regulate the amount of gaseous hydrogen produced in relation to the parameterization of the spring of the piston element, of the sizes of the fluidic conduit and of the tank chamber and of the reaction chamber. Moreover, a possibility is to be noted to realise cartridges as energy generators for energy accumulators or as disposable cartridges for portable applications.

A further advantage of an embodiment of a cartridge is its efficiency that makes it favorable the realization of cartridges with very small capacities of the reactant. In fact, the possibility to choose the characteristics of rigidity and of length of the spring may make it possible the transfer of the reactant into the reaction chamber through the fluidic conduit with a constant capacity in time even if the volume of the reactant extremely reduced.

A further advantage of an embodiment of the cartridge is the uncommonly favorable attainment from the environmental respect viewpoint, in fact the cartridge generates gaseous hydrogen transforming mechanical energy suitably stored. In this way it may be possible to recharge electronic devices or generate energy with the help of hydrogen motors without the use of the main electric network.

Another advantage of a cartridge according to an embodiment is the compactness, in fact the reactant, that is a source wherefrom the hydrogen is extracted, and the reactor, for the production of gaseous hydrogen are contained in a single piece. It is also to be noted that the reaction chamber is also the storage chamber of the reaction by-products.

Another remarkable advantage of an embodiment of a cartridge is the possibility to realise rechargeable cartridges, in fact while the reaction by-products contained in the reaction chamber are combined with the hydrogen for generating water, the piston element may be easily recovered.

Another advantage of an embodiment of a cartridge is the safety given by the coupling element that, realized as separated element, allows to avoid any non controlled contact between the solution of catalyst and the reactant for generating gaseous hydrogen.

Another advantage of an embodiment is the possibility to realize cartridges that have an operation independent from their space position.

Another remarkable advantage of an embodiment of a cartridge is given by the control means that allow blocking and re-activating the production of gaseous hydrogen on demand with a simple cut-off of the flow of the reactant in the reaction chamber.

Of course, one with the aim of meeting incidental and specific needs may modify or replace some parts or details of the cartridge or of the system above described with others being technically equivalent to realize further versions.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. An apparatus, comprising:
a housing having a first side wall, a reactant-storage chamber, and a reaction chamber;
a piston disposed within the housing between the reactant-storage chamber and the reaction chamber;
a reactant-discharge port extending into the reactant-storage chamber;
a reactant-entry port extending into the reaction chamber; and
a device operable to urge the piston toward the reactant-storage chamber.

17. The apparatus of claim 16 wherein the housing sidewall is approximately cylindrical.

18. The apparatus of claim 16 wherein the piston forms a seal with the sidewall.

19. The apparatus of claim 16 wherein the device comprises a spring.

20. The apparatus of claim 16 wherein the device comprises a compressed spring disposed in the reaction chamber.

21. The apparatus of claim 16 wherein the reactant-discharge port extends into the reactant-storage chamber through the sidewall of the housing.

22. The apparatus of claim 16 wherein the reactant-entry port extends into the reaction chamber through the sidewall of the housing.

23. The apparatus of claim 16 wherein:
the housing has an end; and
the reactant-discharge port extends into the reactant-storage chamber through the end of the housing.

24. The apparatus of claim 16, further comprising a reactant disposed in the reactant-storage chamber.

25. The apparatus of claim 16, further comprising sodium tetrahydroborate disposed in the reactant-storage chamber.

26. The apparatus of claim 16, further comprising a catalyst disposed in the reaction chamber.

27. The apparatus of claim 16, further comprising a group VIIIB metal disposed in the reaction chamber.

28. The apparatus of claim 16, further comprising Ruthenium disposed in the reaction chamber.

29. The apparatus of claim 16, further comprising at least one of Cobalt, Nickel, and Platinum disposed in the reaction chamber.

30. The apparatus of claim 16, further comprising water disposed in the reaction chamber.

31. The apparatus of claim 16, further comprising a conduit disposed between the reactant-discharge port and the reactant-entry port.

32. The apparatus of claim 16, further comprising:
a conduit disposed between the reactant-discharge port and the reactant-entry port; and
a valve disposed in the conduit.

33. The apparatus of claim 16, further comprising a reaction-product-discharge port extending through the housing sidewall into the reaction chamber.

34. The apparatus of claim 16, further comprising:
wherein the housing has an end; and
a catalyst-entry port extending through the end of the housing into the reaction chamber.

35. The apparatus of claim 16, further comprising:
wherein the housing has an end;
a catalyst-entry port extending through the end of the housing into the reaction chamber; and
a catalyst-loading device operable to engage the catalyst-entry port, and to hold a catalyst until the catalyst-loading device has engaged the catalyst-entry port.

36. The apparatus of claim 16, further comprising:
wherein the housing has an end;
a catalyst-entry port extending through the end of the housing into the reaction chamber; and
a catalyst-loading device operable to engage the catalyst-entry port and to release a catalyst into the reaction chamber only after the catalyst-loading device has engaged the catalyst-entry port.

37. The apparatus of claim 16, further comprising a valve disposed in the reactant-discharge port.

38. The apparatus of claim 16, further comprising a valve disposed in the reactant-entry port.

39. The apparatus of claim 16 wherein the housing has a second side wall that defines, between the first and second sidewalls, a conduit between the reactant-discharge and reactant-entry ports.

40. The apparatus of claim 16 wherein:
the housing has a second sidewall that forms a reaction-product chamber between the first and second sidewalls;
a first reactant-product-discharge port extending through the first sidewall between the reaction chamber and the reaction-product chamber; and
a second reactant-product-discharge port extending into the reaction-product chamber through the second sidewall.

41. The apparatus of claim 16 wherein:
the housing has a second sidewall that forms a reaction-product chamber between the first and second sidewalls;
a first reactant-product-discharge port extending through the first sidewall between the reaction chamber and the reaction-product chamber;
a filter operable to allow only a reactant product to flow from the reaction chamber through the first reactant-product-discharge port; and
a second reactant-product-discharge port extending into the reaction-product chamber through the second sidewall.

42. A power supply, comprising:
an apparatus, comprising:
a housing having a first side wall, a reactant-storage chamber, and a reaction chamber;
a piston disposed within the housing between the reactant-storage chamber and the reaction chamber;
a reactant-discharge port extending into the reactant-storage chamber;
a reactant-entry port extending into the reaction chamber;
a reaction-product discharge port extending into the reaction chamber; and
a device operable to urge the piston toward the reactant-storage chamber; and
a generator coupled to the reaction-product discharge port and operable to convert a reaction product into electric power.

43. A system, comprising:
a power supply, comprising:
a first apparatus, comprising:
a housing having a first side wall, a reactant-storage chamber, and a reaction chamber;
a piston disposed within the housing between the reactant-storage chamber and the reaction chamber;
a reactant-discharge port extending into the reactant-storage chamber;
a reactant-entry port extending into the reaction chamber;
a reaction-product discharge port extending into the reaction chamber; and
a device operable to urge the piston toward the reactant-storage chamber; and
a generator coupled to the reaction-product discharge port and operable to convert a reaction product into electric power; and
a second apparatus coupled to the generator.

44. The system of claim 43 wherein the second apparatus comprises an integrated circuit.

45. The system of claim 43 wherein the second apparatus comprises a portable apparatus.

46. The system of claim 43 wherein the second apparatus comprises a non-portable apparatus.

47. A method, comprising:
causing a reactant to flow from a storage portion of a housing to a reaction portion of the housing, the reaction portion containing a catalyst; and
allowing a reaction to occur between the reactant and catalyst in the reaction portion while the reactant is flowing from the storage portion to the reaction portion.

48. The method of claim 47 wherein causing the reactant to flow comprises moving a piston that is disposed within the housing between the storage portion and the reaction portion toward the storage portion.

49. The method of claim 47 wherein causing the reactant to flow comprises shrinking a size of the storage portion and expanding a size of the reaction portion.

50. The method of claim 47 wherein the reactant comprises sodium tetrahydroborate.

51. The method of claim 47 wherein the catalyst comprises a group VIIIB metal.

52. The method of claim 47, further comprising halting the flow of the reactant.

53. The method of claim 47, further comprising halting the reaction.

54. The method of claim 47, further comprising halting the reaction by halting the flow of the reactant.

55. The method of claim 47, further comprising allowing a product of the reaction between the reactant and catalyst to exit the reaction portion of the housing.

56. The method of claim 55 wherein the product of the reaction comprises hydrogen.

57. The method of claim 47, further comprising generating electricity in response to a product of the reaction between the reactant and the catalyst.

58. The method of claim 47, further comprising:
generating electricity in response to a product of the reaction between the reactant and the catalyst; and
powering a device with the electricity.
